(19) United States
(12) Patent Application Publication
(10) Pub. No.: US 2009/0094344 A1
(43) Pub. Date: Apr. 9, 2009

(54) METHOD, MULTIMEDIA DEVICE FOR THE TRANSMISSION AND/OR RECEPTION OF MULTIMEDIA DATA VIA A DATA TRANSMISSION SYSTEM, AND GATEWAY FOR CONNECTING A MULTIMEDIA DEVICE TO A DATA TRANSMISSION SYSTEM ACCORDING TO THE FLEXRAY STANDARD

(76) Inventors: Thomas Fuehrer, Gerlingen (AT); Martin Piastowski, Schwieberdingen (DE)

Correspondence Address: KENYON & KENYON LLP, ONE BROADWAY, NEW YORK, NY, 10004, US

(21) Appl. No.: 12/097,894

(22) PCT Filed: Dec. 12, 2006
(86) PCT No.: PCT/EP2006/069607

§ 371 Date: Oct. 27, 2008

(30) Foreign Application Priority Data
Dec. 21, 2005 (SE) 10 2005 061 141.9

(51) Int. Cl. G06F 15/16; G06F 13/00

(52) U.S. Cl. 709/217; 710/100

(57) ABSTRACT

A method, a multimedia device for transmitting, and/or a multimedia device and a gateway for connecting a multimedia device to a data transmission system are provided. The multimedia data include image and/or sound data in particular. To reduce the number of bus systems used in a motor vehicle, utilize existing bus systems in a motor vehicle more efficiently, and thus contribute overall to simplification and optimization of the data transmission within a motor vehicle, the multimedia data is transmitted via a data transmission system according to the FlexRay standard. Predefinable parameters of the FlexRay data transmission system are advantageously varied as a function of the format of the multimedia data and/or a repetition rate of a multimedia source which provides the multimedia data. In this way, particularly efficient and effective transmission of the multimedia data, which conserves resources and is thus cost-effective in particular, is possible.

### FIELD OF THE INVENTION

The present invention relates to a method for transmitting multimedia data provided in a specific format. The present invention also relates to a multimedia device for transmitting multimedia data via a data transmission system and for receiving multimedia data transmitted via a data transmission system. Finally, the present invention also relates to a method for connecting a multimedia device to a data transmission system.

### BACKGROUND INFORMATION

The multimedia equipment of motor vehicles has developed in recent years from a simple radio, inter alia, having a cassette or CD player, to manifold sophisticated and highly developed information systems. The systems must communicate and interact with one another and, of course, with the users of the information systems. Current motor vehicles have GPS navigation systems which may operate in connection with a security system to ascertain the location of a stolen vehicle. A car phone must interact with the audio device to reduce the volume when a call is made. Speech control and a hands-free device require a microphone which picks up and digitizes the speech. Display systems are required for outputting navigation information, DVD playback, and playing back television images. The safety of the occupants requires that the driver concentrates on controlling the vehicle instead of on the details of the individual components.

All of these multimedia components must have an interface with the driver for operation. Sound and image information must be output in a large selection of formats to inform the driver and/or entertain the passengers. Because the information comes from different sources, the components must be capable of managing and processing information to be able to output it reliably to the user.

Transmitting multimedia data via a data transmission system operating according to the MOST (Media Oriented Systems Transport) standard is conventional. MOST is a multimedia fiber optic network, which is optimized for applications in motor vehicles. A possibility is provided by the MOST bus of developing the components independently of one another and then networking them with one another using standard hardware and/or software interfaces, digital interoperability being ensured.

Additional components and functions may be added easily, because the MOST network provides the infrastructure for information transmission from one component to another. Motor vehicles are adapted individually to the wishes of the buyer already at the dealer and may not be taken from a predefinable list. Safety is increased because the multimedia components have defined interfaces to interact with one another, and may be operated easily via user interfaces.

The MOST bus supports data rates from 5.76 Mb/second up to 24 Mb/second. Parameterization which allows 21.17 Mb/second has been established. The MOST standardization originated from an initiative of the year 1997. At that time, the only commonly used digital data source was the audio CD. Therefore, the MOST data structure was constructed in such a way that CD audio channels could be transmitted optimally using the MOST network. Therefore, each block included 16 MOST data frames.

Each frame has to contain synchronous data, but it may also contain asynchronous data in addition. A maximum of 60 bytes of synchronous data per frame may be transmitted, which also includes audio and video streams. At a frame repetition rate of 44.1 kHz, which corresponds to the CD sampling rate, a data rate results which is compatible with an audio CD (if 3 of the maximum 16 logical channels, which are transmitted according to the time multiplex method, are used). This frame format is optimal for audio CDs, but is poorly suitable for modern video data streams, for example, in the MPEG (Moving Picture Experts Group) format.

Various vehicle networks and/or network architectures are conventional. Typically, these are differentiated according to the application domains. These are founded on different requirements for the data rates, packet sizes, latency times, and transmission jitter (oscillations in the transmission time) in the communication systems.

The fields of application of the multimedia components are divided into system electronics, body electronics, and consumer electronics. System electronics are divided into so-called “fail operational” (original functionality of the components is still completely maintained after breakdown of the components) and “fail safe” (restricted functionality after breakdown of the components by operation in emergency running without impairing the other components) components. Body electronics include only so-called “fail safe” components.

A gateway (network transition, interface) may be situated between the “fail operational” components and the “fail safe” components of the system electronics, and also between the “fail safe” components of the system electronics and the “fail safe” components of the body electronics. A firewall (access protection system) may be situated between the components of the body electronics and those of the consumer electronics.

The components of the system electronics and the body electronics are primarily covered by CAN (controller area network) networking. However, bus systems such as LIN (local interconnected network) have been established as a sub-bus in the field of body electronics. In the field of system electronics, FlexRay is also to be expected in the future. FlexRay may also be established as a backbone network, to which the individual components of the various electronic fields are connected using their sub-networks.

The networking of control units, sensors, and actuators with the aid of a communication system or data transmission system and a communication link, for example, in the form of a bus system, has drastically increased in recent years in modern motor vehicles but also in other fields, for example, in mechanical engineering, in particular in the machine tool field, and in automation. Synergy effects may be achieved by distributing functions to multiple users, such as control units, of the communication system. These are referred to as distributed systems.

Communication between various users of such a data transmission system occurs more and more via a bus system. The communication traffic on the bus system, access and reception mechanisms, and error handling are regulated via a protocol. A conventional protocol is the FlexRay protocol, for example, the FlexRay protocol specification v 2.1 currently being used as a basis. FlexRay is a rapid, deterministic, and error-tolerant bus system, in particular for use in safety-relevant applications in motor vehicles. The FlexRay protocol operates according to the principle of time-division multiple-access (TDMA), fixed time slots being assigned to the users and/or the messages to be transmitted, in which they have exclusive access to the communication link. The time slots repeat in a fixed cycle, so that the instant at which a message is transmitted via the bus may be predicted exactly and the bus access occurs deterministically.

To use the bandwidth for the transmission of messages on the bus system optimally, FlexRay divides the cycle into a static part and a dynamic part or into a static segment and a dynamic segment. The fixed time slots are located in the static part at the beginning of a bus cycle. The time slots are dynamically predefined in the dynamic part. Therein, the exclusive bus access is only made possible for a short time, for the duration of at least one so-called mini-slot. The time slot is only lengthened by the time required for the access when a bus access occurs within a mini-slot. Therefore, bandwidth is thus only consumed when it is also actually required. FlexRay communicates via one or two physically separated lines (so-called channels) at a data rate of at most 10 Mb/second in each case. Of course, FlexRay may also be operated at lower data rates.

The two channels correspond to the physical layer, in particular of the so-called OSI (open system architecture) layer model. The channels are primarily used for redundant and thus error-tolerant transmission of messages, but may also transmit different messages, however, by which the data rates may be doubled. It is also possible that the signal transmitted via the connection lines results from the difference between signals transmitted via the two lines. The physical layer is designed in such a way that it allows electrical or also optical transmission of the signal(s) via the line(s) or transmission in other ways, for example, via radio or optically.

To implement synchronous functions and optimize the bandwidth via small intervals between two messages, the nodes in the communication network require a shared time basis, so-called global time. For the synchronization of local clocks of the nodes, synchronization messages are transmitted in the static part of the cycle, the local clock time of a node being corrected with the aid of a special algorithm in accordance with the FlexRay specification in such a way that all local clocks run synchronously with a global clock.

The encoded data rate for television images provide acceptable image quality for display screen sizes up to 40 inches (101.6 cm) display screen diagonal size. However, significantly smaller displays are used in automobiles. Typical sizes are 10.4 inches (26.42 cm) here. Coding artifacts disturb the human eye less on smaller display screen sizes than on large display screens. Therefore, the data rate may be reduced further for automobile use, without image interference perceivable to the human eye occurring. For video applications, a data rate of 2 Mb/second is realistic. However, video sources in the automobile apply higher data rates than the actually required 2 Mbit/second. A DVD data source has peak data rates of up to 9 Mb/second, while digital terrestrial television is transmitted at 4 Mb/second. The semiconductor industry provides high-performance chip sets which may recode the digital video data to be able to transmit it at lower data rates in the vehicle. The requirements for the bus system in the vehicle are thus reduced. Table 1 shows typical data rates for multimedia applications.

TABLE 1
Typical data rates for multimedia applications

| | Data rate | Data rate |
|---|---|---|
| Application | (unencoded) | (encoded) |
| Television image | 166 Mb/second | 4 Mb/second (MPEG-2) |
| (720 × 576 pixels) | | |
| Videoconference | 31 Mb/second | 1.5 Mb/second (MPEG-1) |
| (288 × 360 pixels) | | |
| Audio CD (stereo) | 1.412 Mb/second | 192 kbit/second (MP3) |

Different bus systems, and sometimes even direct wiring, are frequently used for the various multimedia components in a motor vehicle. Therefore, significant wiring effort for the various bus systems results due to the use shown in Table 1. Mass production effects (reasonable costs and reliable manufacturing) are limited, because different components, e.g., CAN protocol components having associated driver components, must be used for each of the above-mentioned electronic fields, in relation to MOST components having specific driver components.

### SUMMARY

An object of the present invention is to reduce the number of the different bus systems in a motor vehicle, to be able to save weight and costs in this way.

To achieve this object, it is suggested that the multimedia data be transmitted via a data transmission system according to the FlexRay standard.

According to an example embodiment of the present invention, a FlexRay system, which is frequently provided in a vehicle in any case, and thus the FlexRay protocol components having the specific FlexRay driver components, is used for the area of application of consumer electronics. The multimedia data to be transmitted via the FlexRay communication system includes:
data from a DVD source to screens and loudspeakers in the vehicle interior, digital terrestrial television signals received by a digital receiver to screens and associated loudspeakers in the vehicle interior,
digital satellite services received via satellite receivers to screens having associated loudspeakers in the vehicle interior,
audio data from a CD player or a CD changer to loudspeakers in the vehicle interior,
audio data from an MP3 player to loudspeakers in the vehicle interior,
data of terrestrial data services (DVB-T, DVB-H, DAB, UMTS, GPRS, GSM, etc.) from the corresponding data sources to the receivers,
navigation information from a navigation computer to a screen having associated loudspeakers in the vehicle interior,
map information and audio commands from a navigation CD to a navigation computer, and
Internet data from the World Wide Web to screens having associated loudspeakers in the vehicle interior.

The existing FlexRay protocol is configured for the transmission of the multimedia data via the FlexRay communication system in such a way that the bandwidth and throughput requirements from the area of consumer electronics are fulfilled. FlexRay offers 10 Mb/second net data rates having frame sizes of up to 254 bytes. The cycle of the time-controlled protocol may be selected between 16 μs (smallest possible cycle under specific boundary conditions) and 16 ms. Transmission opportunities of a node, such as a DVD source, may occur up to 16 times in the static segment of a FlexRay data transmission cycle and even more often in the dynamic segment of the cycle. The data packets must contain the information content between two sequential transmission possibilities. This may be achieved by data compression on the one hand, by increased transmission frequency on the other hand, and by data buffering at the transmitter and/or receiver. A combination of the various options results in the highest data throughput.

Adaptation of the multimedia sources and multimedia receivers is used to implement the present invention, so that they may transmit and receive data according to the FlexRay protocol via a FlexRay communication system. This may be performed by integrating a FlexRay protocol component having the specific FlexRay driver component into a typical multimedia source. Alternatively, however, it is also possible that typical multimedia sources are connected via a gateway to the FlexRay communication system and/or to the communication link, the gateway containing a FlexRay protocol component and a specific FlexRay driver component. Therefore, the multimedia data generated by the multimedia source in a specific data format is first converted into a data format compatible with the data transmission according to the FlexRay protocol, incorporated into a payload segment of a FlexRay data frame, and then transmitted via the FlexRay data transmission system. At the receiver, the FlexRay data frame is received, the multimedia data is removed from the payload segment of the received FlexRay data frame and transmitted to the receiving multimedia components for further processing. The further processing of the multimedia data includes decoding of the data and optical and/or acoustic output of the data to a user in particular.

### BRIEF DESCRIPTION OF THE DRAWINGS

In the following, a preferred exemplary embodiment of the present invention is explained in greater detail on the basis of the figures. Further features, advantages, and embodiments of the present invention may be inferred from the figures and the associated description of the figures.

FIG. 1 shows a data transmission cycle according to the FlexRay protocol and a data frame from the cycle.

FIG. 2 shows a FlexRay communication system for implementing the method according to the present invention.

### DETAILED DESCRIPTION OF EXAMPLE EMBODIMENTS

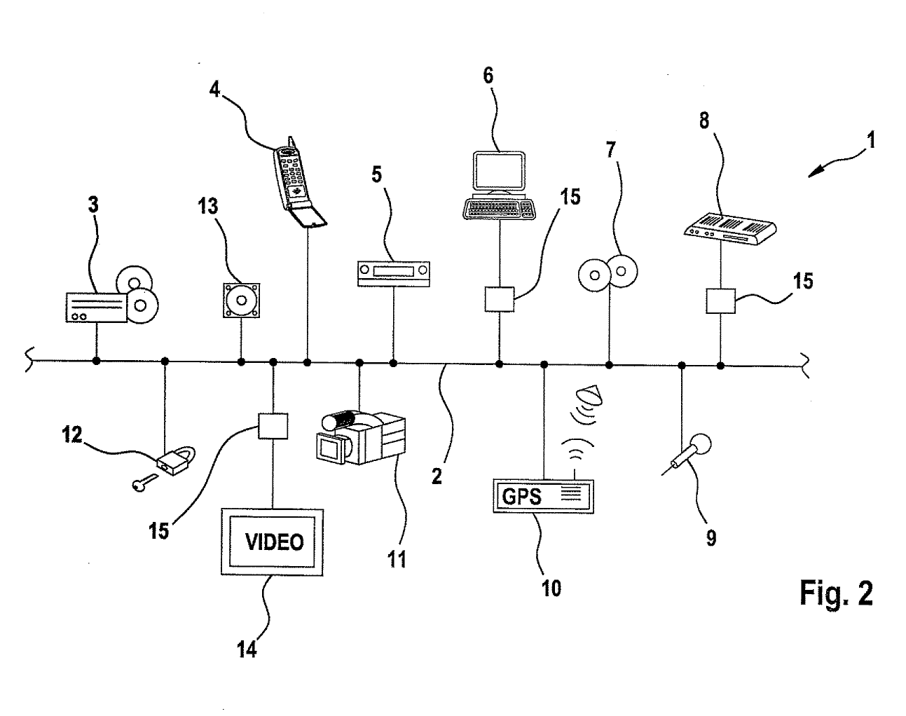

In FIG. 2, a FlexRay data transmission system for implementing the present invention in a vehicle, for example, is identified as a whole by the reference numeral 1. Communication system 1 includes multiple FlexRay nodes, which are connected to one another via at least one connecting line 2. Connecting lines 2 form the physical layer of communication system 1 and may alternatively also be implemented as wireless links or optical links. Connecting lines 2 may be implemented for transmitting optical signals (waveguides) or electrical signals (cables). Multiple nodes 3, . . . , 14 are connected to connecting lines 2. The nodes may be implemented as multimedia sources and/or as multimedia receivers. Examples of a multimedia source are a CD player or a CD changer 3, a cellular telephone 4, which is permanently installed in the vehicle or is mobile, a digital radio 5, a laptop or another computer 6 having multimedia functionality, a CD ROM or DVD player 7, an amplifier 8, a microphone 9, for example, for speech-recognition or for speech control, a navigation unit 10, in particular a GPS navigation unit, a video camera 11 which is permanently installed in the vehicle or is portable, or an interactive vehicle security system 12. Pure multimedia receivers are, for example, loudspeakers 13 (active and/or passive) and a video screen 14. Of the multimedia sources shown, for example, the following may also receive multimedia data: cellular telephone 4, laptop 6, GPS navigation unit 10, and interactive security system 12. Users 3 through 14 are implemented as FlexRay users, i.e., they allow the transmission and/or reception of multimedia data via communication link 2 according to the FlexRay protocol.

FlexRay protocol components, which are assigned to nodes 3 through 14, having specific FlexRay driver components are required for connecting FlexRay nodes 3 through 14 to communication link 2. These components may be integrated directly in nodes 3 through 14, so that a typical multimedia node becomes a FlexRay node 3 through 14, which is connected to FlexRay communication link 2 and may transmit multimedia data according to the FlexRay protocol via connection 2. Alternatively, the FlexRay protocol components having the specific FlexRay driver components are situated in gateways 15, via which typical multimedia nodes 6, 8, 14 are connected to communication link 2.

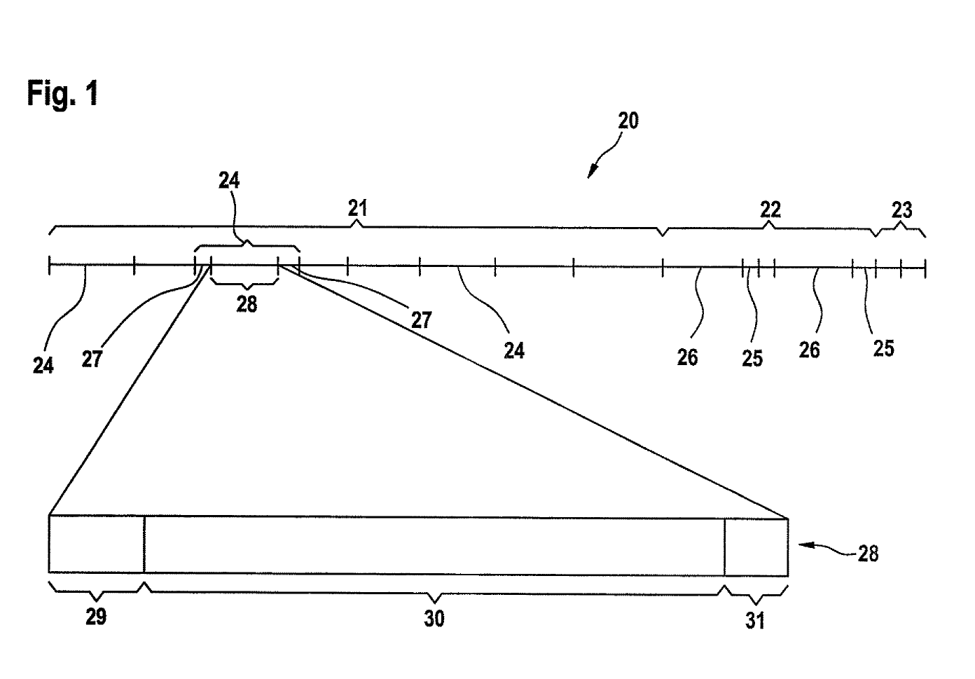

Multimedia data are transmitted within communication system 1 between various nodes 3 through 14 according to the FlexRay standard. One of multiple sequential FlexRay data transmission cycles is identified by reference numeral 20 in FIG. 1. Data transmission cycle 20 includes a static segment 21 and a dynamic segment 22, followed by a symbol window SW and a network idle time NT. SW and NT are identified together by reference numeral 23. Static segment 21 includes time slots 24 having a fixed predefined length. The time slots are dynamically predefined in dynamic segment 22. The exclusive access to FlexRay data bus 2 is made possible only for a short time, for the duration of at least one so-called mini-slot 25, therein. Time slot 26 is lengthened to the time required for access only when a bus access occurs within a minislot 25. Bandwidth is thus only consumed when it is also actually required. Fixed time slots 24 and dynamic time slots 26 are constructed identically in principle. Time slots 24, 26 include an idle time 27 at the beginning and at the end of the time slot and a static or dynamic data frame 28 in between. Data frame 28 is shown enlarged at the bottom of FIG. 1.

At the beginning of data frame 28, a header segment 29 is provided, which has a size of a total of 40 bits. Header segment 29 includes a bit (reserved bit) which is reserved for future expansions. A further bit (payload preamble indicator) is provided thereafter, which indicates the existence of vector information in the payload segment of data frame 28. A further bit (null frame indicator) follows thereafter, which indicates whether the data frame is equal to zero in the payload segment. A further bit (sync frame indicator) indicates the existence of a synchronization data frame. A last bit (startup frame indicator) indicates whether or not the user transmitting a data frame is the startup node. This is followed by an identification of the data frame (frame ID) of 11 bits in length, which is assigned to each of nodes 1 through 14 of data transmission system 1 (valid range: 1 through 2047). This is followed by 7 bits (length), which indicate the data length of the payload segment. Eleven bits (header CRC (cyclic redundancy check)) subsequently follow, which indicate the ascertained CRC values of the bits “sync frame indicator,”¹¹ “startup frame indicator,” “frame ID,” and “length,” which have been calculated by the host computer of the transmitting node. Six bits (cycle count) are provided at the end of header segment 29, which count the cycle of the user which transmits the data frame during the data transmission time.

A payload segment 30, which includes a size of 0 through 254 bytes, follows after header segment 29. The size of payload segment 30 may be selected freely prior to the actual data transmission as a function of the amount of data to be transmitted and the data transmission rate. A 24-bit long trailer segment 31, which includes calculated CRC values, is provided at the end of data frame 28. Overall, a data frame 28 thus has a size of 5 bytes+0 through 254 bytes+3 bytes=8 through 262 bytes.

In an example, a cycle time of 5 ms may be assumed, which is composed of 3 ms for static segment 21 and 2 ms for dynamic segment 22. Thus, static data frames 28 of 128 bytes and dynamic data frames 26 of at most 254 bytes may be assumed. Therefore, in the example, approximately 14 static time slots 24 and approximately 3 dynamic time slots 26 are available; frame overhead and precision observations are taken into consideration in principle.

To transport the coded data rates from Table 1, the data volume must be converted to FlexRay cycle 20 of 5 ms and the number of data frames 28 must be determined. In the standard configuration, a FlexRay data frame 28 is assigned to a time slot 24; 26 and transmitted.

TABLE 2
Derived data rate per 5 ms cycle and determination
of the corresponding data frame size.

| | | | Number |
|---|---|---|---|
| | | | of data |
| | | Data frame | frames/ |
| Data rate | Data rate/5 ms | size/5 ms | 5 ms |
| (encoded) | cycle | cycle | cycle |
| 4 Mb/second (MPEG-2) | 20 kbit/5 ms | 2500 bytes/5 ms | 19.5 |
| 1.5 Mb/second (MPEG-1) | 7.5 kbit/5 ms | 937 bytes/5 ms | 7.3 |
| 192 kbit/second (MP3) | 960 bits/5 ms | 120 bytes/5 ms | 1 |

Thus, the size of data frame 28 per cycle 20 and the number of data frames 28 per cycle 20 are adapted to the particular format of the multimedia data and/or to the repetition rate of the multimedia data to transmit the multimedia data via FlexRay communication system 1, in order to optimize the transmission of the multimedia data via FlexRay communication system 1 to achieve the highest possible data rate and the smallest possible overhead. Of course, other parameters of FlexRay data transmission system 1 may also be varied as a function of the format of the multimedia data to optimize the transmission. For example, a variation of the repetition rate of bus cycles 20 as a function of the repetition rate of multimedia sources 3 through 12 is possible. Providing buffer memories in multimedia users 3 through 14 to buffer multimedia data to be transmitted and/or received is also possible, it being possible to adapt the size of the buffer memory to the data format and/or the repetition rate of the multimedia source or the multimedia receiver.

The FlexRay protocol offers the transmission of messages on two separate channels because of security considerations. These channels may be redundant, but may also be used in parallel, i.e., in principle the FlexRay protocol also allows the transmission of two different messages on the two channels. The two channels may also be received independently of one another. This possibility may be used to double the bandwidth. The data rates specified above in Table 2 may thus be doubled or the number of required time slots 24, 26 may be halved. The two channels may both be situated in static segment 21, both channels then having identical parameters (such as size of data frame 28). However, it is also possible that at least one of the two channels is transmitted via dynamic segment 22, the two channels then also certainly being able to have different parameters.

One interesting aspect of the present invention may be seen in that the FlexRay protocol may be used in combination with a practical communication schedule for data transmission in the area of multimedia, for example, for playing back a multimedia source 3 through 12 and transmitting the multimedia data to screens 14 and loudspeakers 13 in the interior of a vehicle. The following result as possible advantages of the present invention:
Data frames 28 (messages) from the multimedia area are integrated into the area of system electronics. Simplification of the network topology within a motor vehicle results therefrom.
Data frames 28 (messages) from the multimedia area are integrated into the FlexRay backbone. Simplification of the network topology results therefrom.
The FlexRay message catalog is completely adapted (configured) to the requirements of the multimedia area and the highest possible performance for multimedia networking is thus achieved.
Due to the reconfiguration of nodes 3 through 14 from multimedia to FlexRay communication, additional FlexRay protocol components and/or FlexRay driver components are required in users 3 through 14 and/or gateways 15, which results in higher piece counts and therefore lower costs and more reliable manufacturing.
Reduced part costs are to be expected because of the additional mass production effect. The reconfiguration outlay is compensated for or is negligibly low due to the long-term mass production effect.

1-13. (canceled)

14. A method for transmitting multimedia data provided in a specific format via a data transmission system, comprising:
transmitting the multimedia data via the data transmission system according to a FlexRay standard.

15. The method as recited in claim 14, wherein the multimedia data includes at least one of image data and sound data.

16. The method as recited in claim 14, further comprising:
varying predefinable parameters of the FlexRay data transmission system as a function of a format of the multimedia data to optimize transmission of the multimedia data via the FlexRay data transmission system.

17. The method as recited in claim 16, wherein the multimedia data are provided by a multimedia source in a specific data format and transmitted in data frames via the FlexRay data transmission system, a size of a payload segment of a data frame, being adapted to the data format of the multimedia source to optimize transmission of the multimedia data.

18. The method as recited in claim 16, wherein the multimedia data are provided by a multimedia source at a specific repetition rate and are transmitted in repeating bus cycles via the FlexRay data transmission system, the repetition rate of the bus cycles being adapted to a repetition rate of the multimedia source to optimize transmission of the multimedia data.

19. The method as recited in claim 16, wherein the multimedia data are transmitted via the FlexRay data transmission system to a multimedia receiver and are buffered in the multimedia receiver in a buffer memory for further processing, a size of the buffer memory being adapted to at least one of a data format and repetition rate of the multimedia source to optimize transmission of the multimedia data.

20. A multimedia device which provides multimedia data in a specific data format at a specific repetition rate for transmission via a data transmission system, comprising:
a FlexRay communication controller adapted to place the multimedia data into a payload segment of at least one FlexRay data frame; and
a FlexRay bus driver adapted to transmit the at least one FlexRay data frame according to a FlexRay standard via the data transmission system.

21. A multimedia device which receives multimedia data transmitted via a data transmission system and converts the received data into a specific data format having a specific repetition rate for further processing, comprising:
a FlexRay bus driver adapted to receive at least one FlexRay data frame transmitted via the data transmission system according to the FlexRay standard; and
a FlexRay communication controller adapted to remove the multimedia data from a payload segment of the at least one received FlexRay data frame for further processing.

22. The multimedia device as recited in claim 21, further comprising:
an output device adapted to provide at least one of an acoustic and optical output of the multimedia data to a user for further processing.

23. The multimedia device as recited in claim 20, wherein the multimedia device is implemented as a multimedia source.

24. The multimedia device as recited in claim 21, wherein the multimedia device is implemented as a multimedia receiver.

25. The multimedia device as recited in claim 20, wherein the multimedia device is implemented as one of the following devices: an analog or digital radio, an audio CD source, a video DVD source, an amplifier, a microphone for a speech-recognition device or a speech control device, a navigation system, a video camera, a video screen, an interactive antitheft alarm system having vehicle locating, a CD or DVD changer, a loudspeaker, or a cellular telephone.

26. A gateway for connecting a multimedia device to a data transmission system, the multimedia device providing multimedia data in a specific data format, comprising:
a receiver adapted to receive the multimedia data from the multimedia device;
a FlexRay communication controller adapted to place the multimedia data into a payload segment of at least one FlexRay data frame; and
a FlexRay bus driver adapted to transmit the at least one FlexRay data frame according to a FlexRay standard via the data transmission system.

27. A gateway for connecting a multimedia device to a data transmission system, the gateway receiving multimedia data from the data transmission system, converting the received data into a specific data format, and transmitting the converted data to the multimedia device, the gateway comprising:
a FlexRay bus driver adapted to receive at least one FlexRay data frame transmitted via the data transmission system according to a FlexRay standard;
a FlexRay communication controller adapted to remove the multimedia data from a payload segment of the at least one received FlexRay data frame; and
a transmitter adapted to transmit the multimedia data to the multimedia device.
